(19) United States
(12) Patent Application Publication
(10) Pub. No.: US 2003/0127259 A1
(43) Pub. Date: Jul. 10, 2003

(54) Transport arrangement and method of controlling a transport arrangement

(76) Inventor: Erik Landsperg Logstrup, Katunayeka, IPZ (LK)

Correspondence Address: MERCHANT & GOULD PC, P.O. BOX 2903, MINNEAPOLIS, MN, 55402-0903, US

(21) Appl. No.: 10/181,367

(22) PCT Filed: Jan. 17, 2001
(86) PCT No.: PCT/DK01/00033

(30) Foreign Application Priority Data
Jan. 17, 2000 (DK) PA 2000 00074

(51) Int. Cl. B62D 61/10

(52) U.S. Cl. 180/23

(57) ABSTRACT

The invention concerns a transport arrangement (1) for running/movement on uneven surfaces, comprising a frame (5) which on two opposite sides is provided with at least three, preferably four or more, successively arranged actuator legs (2), said actuator legs (2) comprising an upper end (3) and a lower end (4), to which upper end (3) there is fastened an upper frame (6), and to which lower end (4) there is fastened a movement device (7) for bringing about the forwards and backwards movement of the transport arrangement. Each actuator leg (2) comprises a control means (8) and a turning means (9), where the control means (8) brings about a displacement of the movement device (7) which is vertical in relation to the upper frame (6), and the turning means (9) brings about a movement of the movement device (7) which is circular in relation to the running surface. Activation of the three-dimensional movement of the movement device (7) is brought about with registration means (10). The invention also concerns a method of controlling a transport arrangement (1). The transport arrangement achieved hereby is one which is able to identify a given obstacle and exercise the necessary action, and where during the movement of the transport arrangement its frame(s) remain immovable.

The invention concerns a transport arrangement for operation/movement on uneven surfaces, comprising a frame on two opposite sides of which there are disposed at least three, preferably four or more, successively arranged actuator legs, said actuator legs comprising an upper end and a lower end, to which upper end there is fastened an upper frame, and to which lower end there is fastened a movement device for the implementation of the forwards and backwards movement of the transport arrangement.

The invention also concerns a method of controlling a transport arrangement for bringing about the operation/movement on uneven surfaces, for example staircases.

From EP 0 100 449 A1 there is known a transport arrangement used for wheelchairs with specific regard to transport up and down a staircase. The transport arrangement comprises two vertical frames displaced in parallel, an upper frame and a lower frame, where on the longitudinal side these are held together by four symmetrically-arranged piston-cylinder units, said piston-cylinder units comprising at least one wheel at their lower ends. Seen from the side, the frames can thus be adjusted by means of the piston-cylinder units as a form of parallelogram. For the stabilisation and respectively the fixing of the positions of the piston-cylinder units, between and on the longitudinal side of the upper and the lower frame there is provided a further pneumatic cylinder.

On top of the upper frame there is placed a frame for the mounting of a seat, the rearmost frame part of which is secured to the upper frame and, approximately in the centre, is secured to a stabilising system comprising two side bars which, at their other ends, are fixed to the lower frame.

When, for example, the wheelchair is to be conveyed up and down a staircase, the rearmost wheels are driven backwards at low speed by means of drive motors. When leaf contacts on the rearmost pair of wheels abut up against the first step, some side switches disposed on the leaf contacts are activated and all of the wheel sets' integrated microprocessors are selected in a level-regulation arrangement and control unit, partly for stopping the drive motors and partly for the activation of all cylinders with compressed air, with the exception of the two rearmost cylinders, so that the rearmost set of wheels are lifted upwards together with the frames until the leaf contacts no longer abut up against the step. When a vertical tilting is thus effected, the seat will retain its horizontal position due to the stabilising system, while the upper frame and the lower frame will form a parallelogram.

The manner in which the wheelchair is conveyed up and down the staircase gives rise to an unexpected jolt when the leaf contacts abut against a step, and also that the wheelchair is not constructed to compensate for e.g. irregularities in the steps, whereby there arises the risk that the wheelchair can topple. Moreover, the construction of the wheelchair is exposed to unequal distribution of forces during movement up the stairs, in that the construction follows the wheels' vertical positions, while at the same time a pressure must be maintained on the seat frame so that this can maintain its horizontal position.

Furthermore, the way in which an unevenness is registered, i.e. when the leaf contact abuts against the unevenness, will not be able to be used in connection with, for example, terrain-running, in that the risk that the wheelchair will topple is too great. The above transport arrangement for wheelchairs is thus suitable for operation only where the irregularities are well-defined as, for example, on a uniform flight of stairs.

The object of the present invention is to provide a transport arrangement which solves the above-mentioned problems, and where the transport arrangement can operate on uneven surfaces/areas with persons or material without any risk of toppling, and where the upper frame of the transport arrangement remains horizontal during its movement, and that the transport arrangement can be manoeuvred around without occupying unnecessary space.

This object is achieved with a transport arrangement of the kind disclosed in the introduction, and also where each actuator leg comprises a control means and a turning means, where said control means brings about a vertical displacement of the movement device in relation to the upper frame, and where said turning means brings about a circular movement of the movement device in relation to the running surface, and where activation of a three-dimensional movement of the movement device, forwards and backwards, vertical movement and circular movement in relation to the running surface, is brought about by registration means.

There is hereby achieved a transport arrangement which, due to the positioning of the registration means, is not only able to identify a given unevenness, but also to exercise the action necessary to overcome the unevenness, also including greatly undulating areas, which would otherwise be inaccessible. Consequently, when the transport arrangement approaches an unevenness, the registration means will observe the given unevenness and activate the actuator legs for a vertical displacement in accordance with the observations. And this is regardless of whether the transport arrangement moves forwards or backwards or is about to make a turn. Thus only the actuator legs will be displaced, and persons or materials which are placed on the transport arrangement will hereby appear as immovable in relation to the frame.

By providing a transport arrangement according to the invention and as further disclosed in claims 2 and 3, it is achieved that the wheels can individually effect a forwards and backwards movement, and that the actuator legs can effect a vertical displacement, so that the upper frame remains immovable.

By providing a transport arrangement according to the invention and as further disclosed in claim 4. It is achieved that it becomes possible to turn and control the radial movement of the transport arrangement during its longitudinal movement.

By providing a transport arrangement according to the invention and as further disclosed in claims 5 and 6, it is achieved that any unevenness can be accurately identified on the basis of the positions of the actuator legs in relation to the unevenness.

By providing a transport arrangement according to the invention and as further disclosed in claim 7, it is achieved that the transport arrangement can be adapted to suit a specific work area or area of use.

In accordance with the introduction to claim 8, the invention also concerns a method of controlling a transport arrangement for operation/movement on uneven surfaces, comprising a frame on which an two opposite sides there are disposed three, preferably four, successively arranged actuator legs, said actuator legs comprising an upper end and a lower end, on which lower end there is disposed a wheel for bringing about the movement of the transport arrangement.

The method according to the invention is characterised in that the transport arrangement comprises sensors which activate a three-dimensional movement of the wheel, a forwards, backwards and a vertical movement and a circular movement in relation to the running surface, said movements being arranged to accommodate the character of the unevenness, where said character can be divided into steps.

It is hereby achieved that regardless of how the barrier manifests itself, the transport arrangement will always have at least a half part of the total number of actuator legs placed on an under layer, which results in a stability of the object placed on the transport arrangement, for example a person, said stability being further reinforced by virtue of the support surface of the transport arrangement remaining horizontal during the whole of the transport arrangement's movement.

By making use of a method according to the invention and as disclosed in claims 9 and 10, it is achieved that the movement of the transport arrangement will remain smooth, partly because the upper frame will remain immovable in relation to the actuator legs, and partly because the unevenness is registered in good time so that the actuator legs are not brought into collision with the unevenness.

By making use of a method according to the invention and as further disclosed in claims 11 and 12, it is achieved that the transport arrangement uses an inverse sequence, so that a front and rear end of the transport arrangement need not necessarily be defined. Moreover, the effect of the registration of the unevenness is that the transport arrangement will not topple forwards.

By making use of a method according to the invention and as further disclosed in claim 13, it is achieved that regardless of where the transport arrangement moves, it will not only be able to register the orientation of the unevenness, but also be able to overcome it, so that the transport arrangement does not topple.

The invention also concerns a use of the transport arrangement according to claims 1-7 for the execution of the method according to claims 8-13.

The invention will now be explained in more detail with reference to the drawing, where

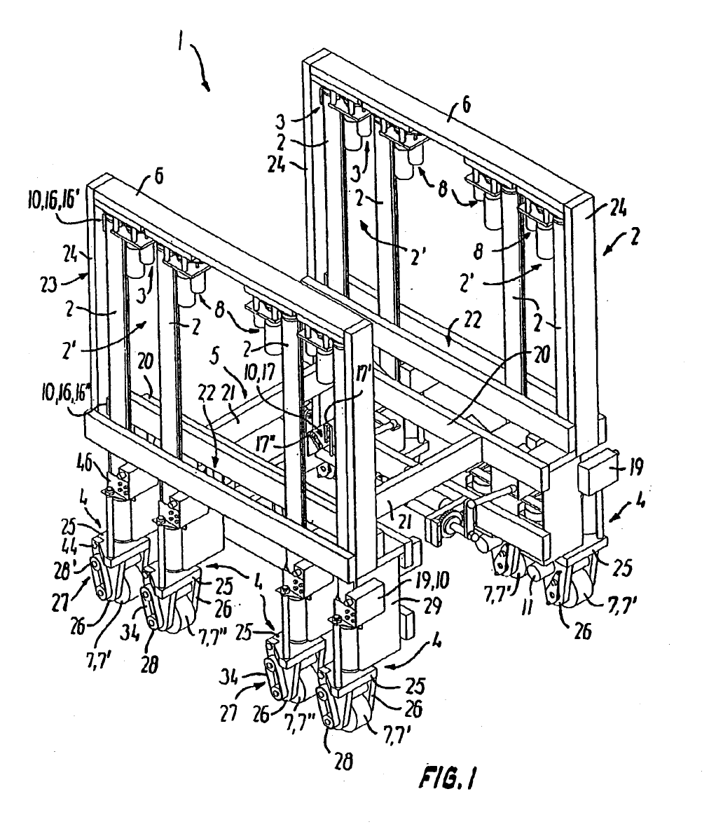

FIG. 1 shows a transport arrangement according to the invention in perspective,

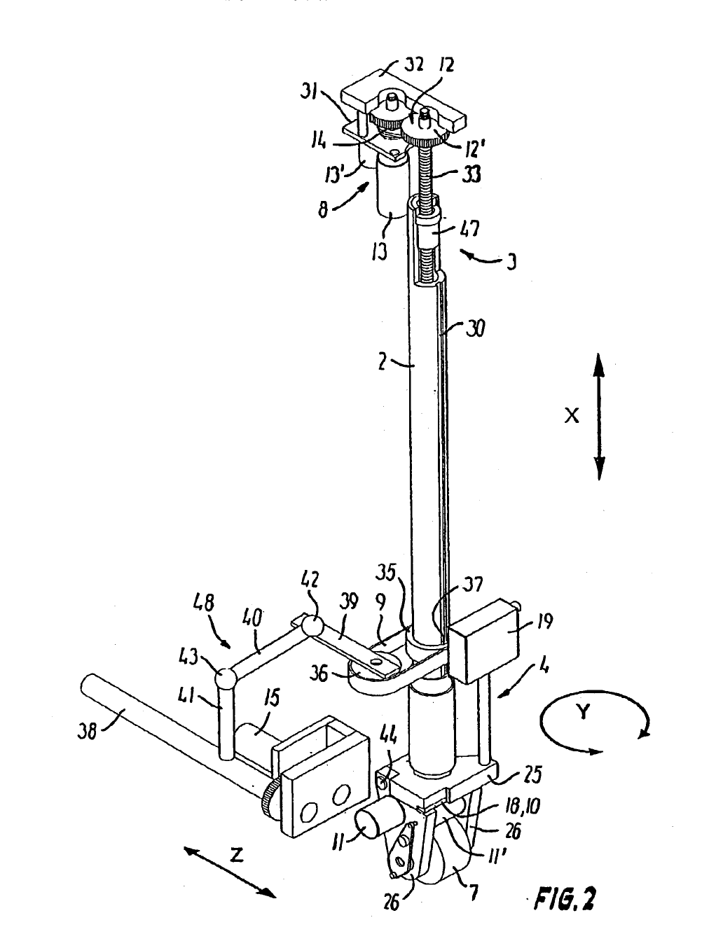

FIG. 2 shows a single actuator leg with control means, steering mechanism and movement device mounted,

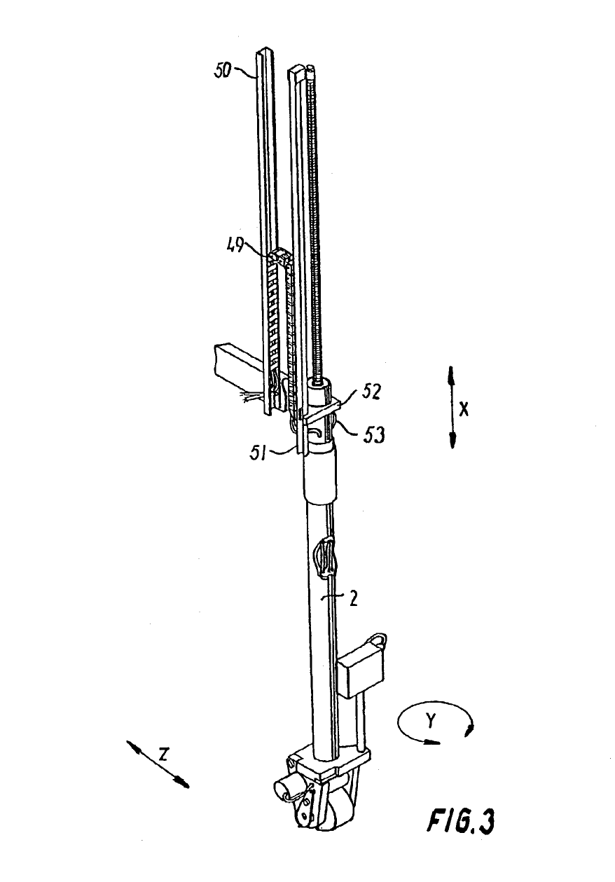

FIG. 3 shows the actuator leg shown in FIG. 2 with guiding rail mounted, and

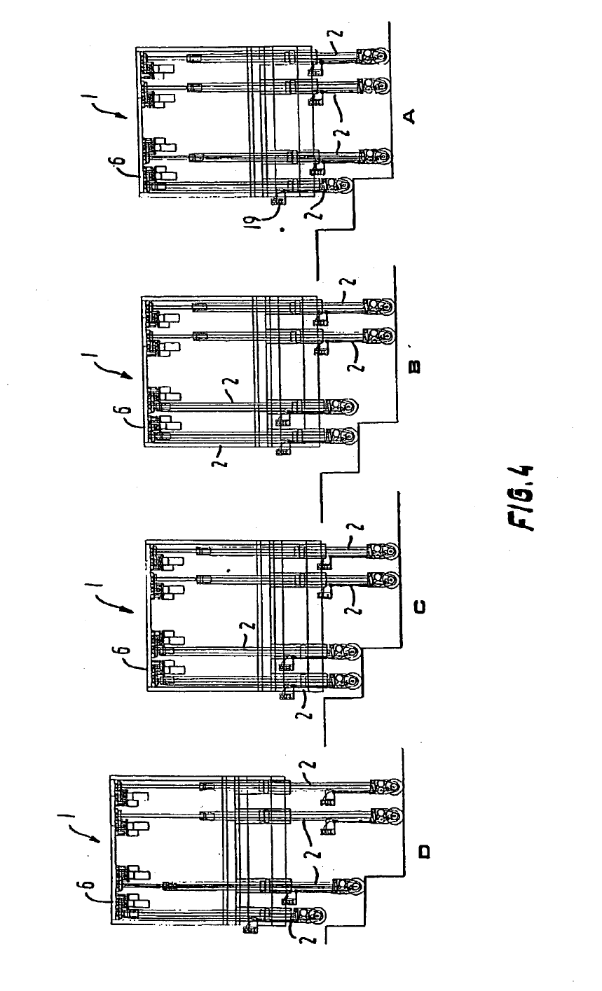

FIGS. 4-6 show the steering procedure for a transport arrangement according to the invention for execution of the action necessary for overcoming an unevenness.

FIG. 1 is a perspective view of a transport arrangement 1 according to the invention, comprising a frame 5, and where on two opposite sides of said frame 5 there are provided four successively arranged actuator legs 2.

The frame 5 is not of any certain configuration, and in principle it can assume any fashion whatsoever. In the example embodiment, the frame 5 comprises two longitudinal sides 20 displaced in parallel from each other, and fastened to each other by two transverse sides 21.

Along each longitudinal side 20 there are four actuator legs 2 disposed in pairs in the forming of four pairs of actuator legs 2′, where each pair of actuator legs 2′ thus comprise a first wheel 7′ and a centre wheel 7″. On each side of the frame 5, the two pairs of actuator legs 2′ are partly surrounded by a frame 23 comprising a horizontal upper frame 6, two side frames 24, which are parallel with the actuator legs 2, and a lower frame 22 displaced vertically parallel in relation to the upper fame 6, this frame 22 substantially surrounding the lowermost part of the actuator legs 2.

Each of the actuator legs comprises an upper end 3 and a lower end 4. On the upper end 3 there is provided a control means 8, said control means 8 also being fastened to the upper frame 6. On the lower end 4 there is mounted a movement device 7 in the form of a wheel which thus brings about the movement of the transport arrangement. The control means 8 will be described further with reference to FIG. 2.

Above the wheel 7 there is disposed a horizontal wheel holder 25 which extends substantially over the whole breadth of the wheel. On the wheel holder 25, and on each side of the wheel 7 and facing towards the running surface, a flexible stop unit 26 is disposed by means of a hinge 44. On that side of the stop unit 26 which faces towards the frame 5 of the transport arrangement, under the wheel holder 25 there is mounted a drive motor 11, and on the opposite side a belt drive 27. The belt drive 27 comprises a belt 34 extending between two staggered bearings, where the axis of the one bearing 28 coincides with the centre axis of the wheel, while the second bearing 28′ is displaced towards the hinge 44, so that the axis of the bearing becomes coincident with the axis (not shown in the drawing) of the drive motor. The belt drive 27 is thus controlled by the drive motor 11, whereby the forwards and backwards movement of the wheel is established (see arrow indication Z in FIG. 2).

A bracket 29 is provided between the wheel holder 25 and the lower frame 22, and on this bracket 29, facing away from the frame 5, there is placed a holder 46 for the mounting of a fourth registration unit 19 comprising a distance sensor for registration of the distance from the transport arrangement 1 to a given unevenness. The registration is sent back to a micro-controller (not shown in the drawing), where this brings about the action necessary for the transport arrangement 1 to be able to overcome the unevenness. For example, this can be effected by frequent transmission by the sensor 19 of signals of a given frequency and herewith wavelength over a given extent of the running surface. When there are no irregularities, the characteristic of the return signal will be the same as that transmitted, and the micro-controller will not implement any action. This means, for example, that a horizontal running surface serves as a reference. If the return signal appears different from the transmitted signal, this is a sign that the running surface assumes a form which differs from the reference, and depending on the return signal, the running surface will either rise or fall. Hereafter, the micro-controller will bring about the action necessary for the transport arrangement 1 to be able to overcome the unevenness.

On two additional actuator legs 2 comprising a first wheel 7′, there is mounted a second registration unit 17 comprising two sensors 17′, 17″, which respectively register the wheel's right/left limit and centre limit when turning. The registration can, for example, be effected in accordance with the above-mentioned principle, but merely with another reference.

How the wheel 7 can be turned will be described with reference to FIG. 2.

On two actuator legs 2, opposite in relation to above-mentioned actuator legs 2, one on each side of the frame 5 and comprising a first wheel 7′, there is mounted a first registration unit 16 comprising two sensors which respectively register the actuator leg's upper limit 16′ and lower limit 16″, or minimum and maximum height of the actuator legs 2 by vertical displacement. The registration can be effected in accordance with the same principle as described earlier, but for example merely with a registration point on the side frame 24 as reference. How the vertical displacement of the actuator legs is brought about will be described with reference to FIG. 2.

By virtue of its construction, the transport arrangement 1 does not comprise ends which are decidedly front and rear, and for this reason the placing of the second registration unit 17 and fourth registration unit 19 respectively can take place on both the foremost actuator leg 2, one on each side of the frame 5, as well as on the rearmost actuator leg 2, similarly placed on each side of the frame 5. The respective registration units 17,19 are simply placed opposite each other.

The positioning of the above-mentioned registration units 16, 17 and 19 is arbitrary and they can be placed as desired, though in such a manner that they can each register that for which they are determined.

FIG. 2 shows a single actuator leg 2 for the transport arrangement 1 according to the invention, and with control means 8, turning means 9 and movement device 7 mounted.

The actuator leg 2 comprises an upper end 3 and a lower end 4, between which ends 3,4 there is provided a through-running keyway 30. In extension of the upper end 3 there is provided a set of gears 12 which, at the one end facing towards the lower end 4 of the actuator leg 3, is fastened to a lower plate 31, and at the opposite end is connected to an upper plate 32, said upper plate 32 also being connected to the upper frame 6 (see FIG. 1).

On the lower plate 31, on the side opposite to that on which the set of gears 12 is disposed, there is provided an actuator motor 13 with an associated DC solenoid 13′. The actuator motor 13 is in direct connection with the set of gears 12, and thus controls the movement of the gears. The DC solenoid 13′ constitutes an actuator stop 14 for the actuator motor 13, so that the movement of the gears 12 and the actuator leg can be stopped. For example, in the event of failures the DC solenoid will not be able to be activated and the set of gears 12 will be immovable.

Through the one gear 12′ in the set of gears 12 there is provided a control means 8 comprising a displacement element 33, preferably a spindle 33, around which there is a bush 47. The displacement element 33 extends through the actuator leg 2 and down to its lower end 4 which comprises a movement device 7 in the form of a wheel. When the set of gears is activated for a rotation, the spindle 33 will either turn clockwise or counterclockwise, whereby the actuator leg 2, and herewith the wheel 7, will be displaced vertically either by an extension or a retraction (see the arrow indication X). By the displacement, the spindle 33 and the actuator leg 2 will be movable, partly in relation to the bush 47 and partly in relation to the up per plate 32 which is fastened to the upper frame 6. In the event of failures, for example, the actuator stop 14 will thus also have influence on the movement of the spindle, whereby in the given situation a vertical displacement of the actuator leg 2 will not be able to be effected.

Above the wheel 7 there is placed a wheel holder 25, to the two opposite sides of which there is fastened a flexible stop unit 26 by means of a hinge 44. On the stop unit 26 there is mounted a drive motor 11 with an associated DC solenoid 11′, where the DC solenoid 11′ is placed between the wheel 7 and the wheel holder 25. The DC solenoid 11′ constitutes a brake for the drive motor 11′, so that the forwards and backwards movement of the wheel can be stopped. In the event of failures, the DC solenoid 11′ will thus be able to be activated and the wheel 7 will be immovable.

On the wheel holder 25, facing towards the wheel 7, there is mounted a third registration unit 18 comprising a touch-sensor which registers whether the wheel is in contact with the running surface. When the wheel 7 is not in contact with the running surface, a gap will arise between the wheel holder 25 and the flexible brake unit 26. This is registered by the touch-sensor 18, and in this situation a movement of the wheel 7 will thus not be able to be effected.

The fourth registration unit 19 is mounted facing towards the upper end 3 of the actuator leg on the wheel holder 25, and as mentioned comprises a distance sensor for registration of the distance from the transport arrangement 1 to a given unevenness.

The turning means 9 is mounted above the wheel holder 25 and comprises a belt which extends between an actuator bush 35 on the actuator leg 2 and a further bush 36. Facing towards the actuator leg 2, the actuator bush 35 comprises a projection 37 which is shaped for engagement in the through-running keyway 30 in the actuator leg. The additional bush 36 is connected to a steering mechanism 48 comprising a first steering arm 39, a connection arm 40 and a second steering arm 41. The first steering arm 39 is connected by its one end to the bush 36, and at its other end is connected to the connection arm 40 by a link 42 which is pivotal horizontally. The other end of the connection arm is pivotally connected to the second steering arm 41 by a conventional ball bearing 43. The other end of the second steering arm 41 is fastened to a shaft 38, to which shaft 38 there is also fastened a motor 15.

When the motor 15 is activated, the result is that the shaft 38 can assume different positions, whereby the belt 45 is displaced from its position and, due to the projection 37, the actuator log 2 will follow this movement and rotate around its longitudinal axis. Since the wheel 7 is connected to the actuator leg 2 by the spindle 33, it can thus give rise to a horizontal circular movement of the transport arrangement 1, either to the right or left (see arrow indication Y).

In order for the wheel 7 to be able to effect a horizontal circular movement, the wheel 7 must only be pivoted a certain degree, since it would otherwise merely be turned around, and for this reason the second registration unit 17 is mounted comprising two sensors 17′, 17″, which respectively register the robot system's right/left limit and the centre limit when turning. The sensors are shown and described in FIG. 1. When the respective limits have been reached, the motor 15 will thus be deactivated.

It must be added, however, that not all of the actuator legs 2 are turned the same amount during the circular movement. The centre wheels 7″ turn with a smaller radius than the first wheels 7′ (see positioning in FIG. 1), and is brought about individually by the motor 15.

The registration units described above, consisting of a first registration unit (16), a second registration unit (17), a third registration unit (18) and a fourth registration unit (19), are referred to as registration means 10.

The transport arrangement 1 can be electrically driven or battery driven, and the actual steering of the movement of the transport arrangement can be effected manually, automatically or by remote control.

FIG. 3 shows the actuator leg 2 shown in FIG. 2 with guiding rail mounted. The actuator leg 2 has multiple numbers of holes in its lengthwise direction used to lay power and control cables 53 of the driving wheel assembly. It includes motor, encoder, solenoid and sonsor cables. These cables 53 coming out in the upper part of the actuator surface at 45° angle increase the bending angle and thereby safety. Then the cables 53 go throug a flexible chain 49 with both ends fixed to a holding bracket 52 and to a guiding rail 50.

The holding bracket 52 is fixed to the actuator leg by two circlips and the actuator leg can hereby rotate freely with reference to the holding bracket 52. The sliding rail 51 and the guiding rail 50 can be directly fixed to the machine structure. Hereby the sliding rail 51 and the guiding rail 50 will follow the position of the actuator leg 2, up and down.

Because of the above cable management, the actuator leg 2 can move without any interference with the cables 53.

FIGS. 4-6 show the control procedure for a transport arrangement 1 according to the invention for the execution of the action necessary to overcome an unevenness, which in this example embodiment is a staircase.

It must be noted that during the whole of its operation upwards or downwards, the transport arrangement 1 moves forwards, backwards or turns, where the latter movement is described under FIG. 1, and will thus not be discussed further.

In FIG. 4A, the transport arrangement 1 approaches the first step of the staircase, and a distance sensor 19 measures the distance between the bottom of the staircase and the top of the first step. The two actuator legs 2, one on each side of the frame 5, which are closest to the first step, are raised by an amount in accordance with the distance measured, this raising being established by a displacement of the remaining actuator legs 2.

With continued movement forwards, the two actuator legs 2, one on each side of the frame 5, which are now disposed closest to the change in height, are displaced in accordance with the distance measured between the bottom of the staircase and the top of the step (see FIG. 4B). With still further forwards movement, the first four actuator legs 2, two on each side of the frame 5, will be placed on the first step, and the remaining actuator legs 2 are standing on the bottom of the staircase (see FIG. 4C).

During the movement forwards, the two foremost actuator legs 2, one on each side of the frame 5, come close to a second step, and the distance sensor 19 measures the new distance between the first step and the top of the second step. The two actuator legs 2 are now raised further by an amount based on the distance measured, this raising being established by a displacement of the remaining actuator legs 2 (see FIG. 4D).

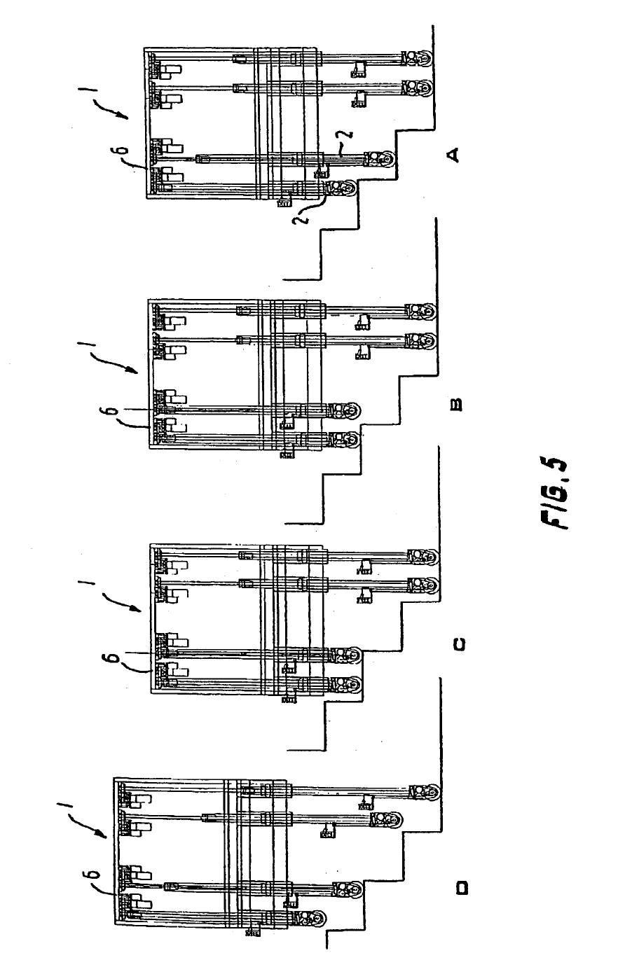

In FIG. 5, the actuator legs 2 are placed respectively on the first and the second step and at the bottom of the staircase. When the actuator legs 2 which are on the first step approach the second step, the distance sensor 19 will measure the new distance between the first step and the top of the second step, after which the actuator legs 2 are raised again (see FIG. 5B). Hereafter, with continued movement of the transport arrangement, there will be four actuator legs 2 standing at the bottom of the staircase, and four actuator legs 2 will be placed on the second step (see FIG. 5C).

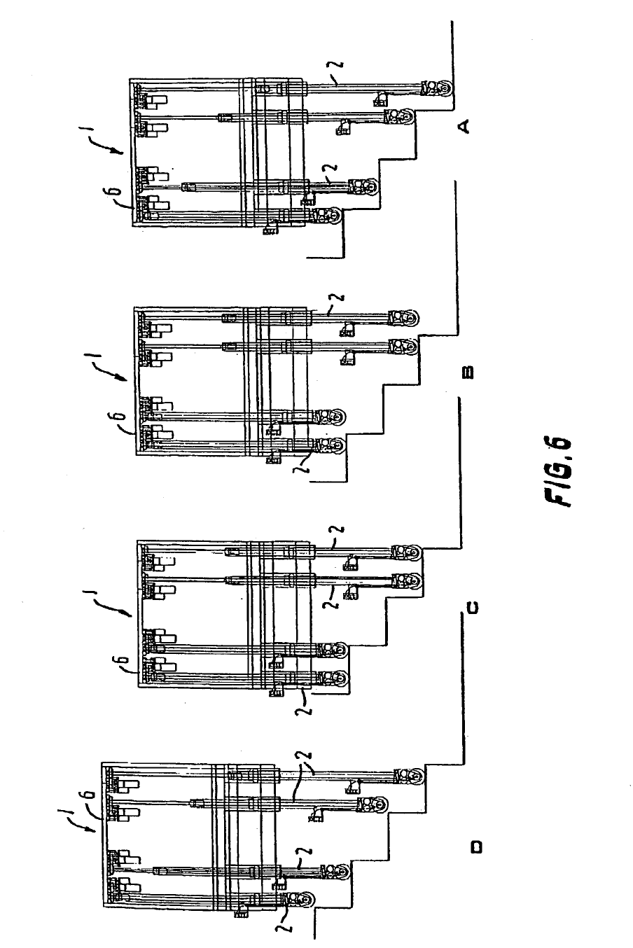

In FIG. 5D, the four actuator legs 2, two on each side of the frame 5 and at each their ends, are in the process of being raised, and this is effected in accordance with the principle already described, where the distance sensor 19 measures the new distance(s) between the preceding surface/step and the top of the subsequent step. The sequence is thus repeated regardless of the number of steps, which will appear further from FIG. 6.

The procedure described above will also apply when the transport arrangement 1 is required to move down an unevenness, in that the sequence is implemented in reverse. Instead of an extension of the actuator legs 2, at the start of a downwards movement these will be extended to the maximum, and will thus be shortened gradually with the appearance of steps.

The movement downwards from the uppermost step on an unevenness or staircase is thus effected by a distance sensor 19 measuring the distance between the running surface and the bottom of the first step down on the staircase. The two actuator legs 2, one on each side of the frame 5, which are closest to the approaching unevenness, are lowered on the basis of the distance measured, this lowering being established by a displacement of the remaining actuator legs 2.

When the unevenness draws closer, the two actuator legs 2, one on each side of the frame 5, which subsequently stand as next closest to the unevenness, will be lowered by the same amount, this lowering being established by each of the two actuator legs' actuator motors 13.

The sequence described above is repeated until no further unevenness is registered, and all of the actuator logs 2 arc thus standing on the same level.

The downwards movement from the top step of a staircase or unevenness to remaining steps is effected by the distance sensor 19 measuring the new distance between the running surface and the top of the next step. The two actuator legs 2, one on each side of the frame 5, which are closest to the next step, are lowered a further amount, which lowering is established by a displacement of the remaining actuator legs 2. The two actuator legs 2, one on each side of the frame 5, which are next closest to the second step, are displaced in accordance with the distance measured between the first step and the top of the second step.

The distance sensor 19 measures the new distance between the second step and the top of the third step, and the distance between the running surface and the top of the first step, and the two actuator legs 2, one on each side of the frame 5, which stand closest to the next step are lowered further, which lowering is established by a displacement of the remaining actuator legs 2, and a displacement is effected of the actuator legs 2 which now stand at the first step.

The sequence is repeated regardless of the number of steps.

In conclusion, it must be noted that as will appear from the FIGS. 4-6, the upper frame 6 of the transport arrangement will remain horizontal during the movement of the transport arrangement.

1. Transport arrangement (1) for operation/movement on uneven surfaces, comprising a frame (5) on two opposite sides of which there are disposed at least three, preferably four or more, successively arranged actuator legs (2), said actuator legs (2) comprising an upper end (3) and a lower end (4), to which upper end (3) there is fastened an upper frame (6), and to which lower end (4) there is fastened a movement device (7) for the implementation of the forwards and backwards movement of the transport arrangement, characterized in that each actuator leg (2) comprises a control means (8) and a turning means (9), where said control means (8) brings about a vertical displacement of the movement device (7) in relation to the upper frame (6), and where said turning means (9) brings about a circular movement of the movement device (7) in relation to the running surface, and where activation of a three-dimensional movement of the movement device (7), forwards and backwards, vertical movement and circular movement in relation to the running surface, is brought about by registration means (10).

2. Transport arrangement (1) according to claim 1, characterized in that the movement device (7) comprises at least one wheel, said wheel(s) being placed in extension of the lower end (4) of the actuator leg (2), and where the forwards and backwards movement of the wheel(s) is brought about by a drive motor (11).

3. Transport arrangement (1) according to any of the foregoing claims, characterized in that the control means (8) comprises a displacement element (33), preferably a spindle, said displacement element (33) being fastened at its one end to the movement device (7), and around which displacement element (33) there is placed a bush (47), in that said displacement element (33) can move vertically, and where said vertical movement is brought about by an actuator motor (13).

4. Transport arrangement (1) according to any of the foregoing claims, characterized in that the turning means (9) comprises a movable belt (45), which belt (45) partly surrounds an actuator bush (35) on the actuator leg (2), said actuator bush (35) comprising a projection (37) which is brought into engagement with a through-running keyway (30) on the actuator leg (2), and where said movement of the belt (45) is brought about by a motor (15).

5. Transport arrangement (1) according to any of the foregoing claims, characterized in that the registration means (10) comprise a first registration unit (16) comprising two sensors, an upper sensor (16′) and a lower sensor (16′), a second registration unit (17) comprising two sensors, a right/left sensor (17′) and a centre sensor (17″), a third registration unit (18) comprising a touch sensor, and a fourth registration unit (19) comprising a distance sensor.

6. Transport arrangement (1) according to claim 5, characterized in that the first registration unit (16) registers the minimum and maximum displacement of the actuator legs, that the second registration unit (17) registers the limit of the movement unit when turning, that the third registration unit (18) registers contact of the movement device (7) with the running surface, and that the fourth registration unit (19) registers the distance to a given unevenness.

7. Transport arrangement (1) according to any of the foregoing claims, characterized in that the movement of the transport arrangement can be controlled manually, automatically or by remote control.

8. Method of controlling a transport arrangement (1) for operation/movement on uneven surfaces, comprising a frame (5) on two opposite sides of which there are disposed three, preferably four or more, successively arranged actuator legs (2), said actuator legs (2) comprising an upper end (3) and a lower end (4), on which lower end (4) there is placed a wheel (7) for effecting the movement of the transport arrangement, characterized in that the transport arrangement (1) comprises sensors (10) by which there is brought about a three-dimensional movement of the wheel (7), a forwards and backwards movement, a vertical movement and a circular movement in relation to the running surface, said movements being arranged to accommodate the character of unevenness/irregularities, where said character can be divided into stepwise intervals.

9. Method according to claim 8, characterized in that the upwards-running to the first stepwise interval of the unevenness is effected as follows:
all actuator legs (2) assume a minimum vertical position,
a distance sensor (19) measures the distance between the running surface and the top of the fist stepwise interval of the unevenness,
the two actuator legs (2), one on each side of the frame (5), which stand closest to the approaching unevenness, are raised by an amount based on the measured distance, said raising being established by a displacement of the remaining actuator legs (2),
the two actuator legs (2), one on each side of the frame (5), which subsequently stand next closest to the unevenness, are raised by the same amount when the unevenness approaches, said raising being established by each of the two actuator legs' actuator motors (13),
the sequence is repeated until there is no longer any unevenness to register, and thus all of the actuator legs (2) are standing on the same stepwise interval.

10. Method according to claims 8-9, characterized in that upwards movement from the first stepwise interval on the staircase or unevenness to remaining stepwise intervals is effected as follows:
the distance sensor (19) measures the new distance between the first stepwise interval and the top of the second stepwise interval,
the two actuator legs (2), one on each side of the frame (5), which stand closest to the next stepwise interval, are raised by a further amount, said raising being established by a displacement of the remaining actuator legs (2),
the distance sensor (19) measures the new distance between the second stepwise interval and the top of the third stepwise interval, and the distance between the running surface and the top of the first stepwise interval,
the two actuator legs (2), one on each side of the frame (5), which stand closest to the next stepwise interval, are raised a further amount, said raising being established by a displacement of the remaining actuator legs (2), and a displacement is effected of the actuator legs (2) which now stand at the first stepwise interval,
the sequence is repeated regardless of the number of stepwise intervals.

11. Method according to claims 8-10, characterized in that downwards movement from an uppermost stepwise interval on an unevenness or staircase is effected as follows:
all actuator legs (2) assume a maximum vertical position,
a distance sensor (19) measures the distance between the running surface and the bottom of the first stepwise interval of the unevenness,
the two actuator legs (2), one on each side of the frame (5), which stand closest to the approaching unevenness, are lowered by an amount on the basis of the measured distance, said lowering being established by a displacement of the remaining actuator legs (2),
the two actuator legs (2), one on each side of the frame (5), which subsequently stand next closest to the unevenness, are lowered by the same amount, which lowering is established by each of the two actuator leg's actuator motors (13),
the sequence is repeated until there is no longer any unevenness to register, and thus all actuator legs (2) stand on the same stepwise interval.

12. Method according to claims 8-11, characterized in that downwards movement from the uppermost stepwise interval on the staircase or unevenness to remaining stepwise intervals is effected as follows:
the distance sensor (19) measures the new distance between the running surface and the top of the next stepwise interval,
the two actuator legs (2), one on each side of the frame (5), which stand closest to the next stepwise interval, are lowered by a further amount, which lowering is established by a displacement of the remaining actuator legs (2),
the two actuator legs (2) one on each side of the frame (5), which stand next closest to the second stepwise interval, are displaced in accordance with the distance measured between the first stepwise interval and the top of the second stepwise interval,
the distance sensor (19) measures the new distance between the second stepwise interval and the top of the third stepwise interval, and the distance between the running surface and the top of the first stepwise interval,
the two actuator legs (2), one on each side of the frame (5), which stand closest to the next stepwise interval, are lowered a further amount, which lowering is established by a displacement of the remaining actuator legs (2), and a displacement is effected of the actuator legs (2) which now stand at the first stepwise interval,
the sequence is repeated regardless of the number of step wise intervals.

13. Method according to claims 8-12, characterized in that during the whole of its movement on unevenness, the transport arrangement (1) moves forwards, backwards and/or sideways.

14. Use of the transport arrangement (1) according to claims 1-7 for the execution of the method according to claims 8-13.
